(19) United States
(12) Patent Application Publication
(10) Pub. No.: US 2009/0237616 A1
(43) Pub. Date: Sep. 24, 2009

(54) Projection type image display device

(75) Inventor: Takatsugu Aizaki, Kanagawa-ken (JP)

Correspondence Address: THE NATH LAW GROUP, 112 South West Street, Alexandria, VA, 22314, US

(73) Assignee: VICTOR COMPANY OF JAPAN, LIMITED, Kanagawa-ken (JP)

(21) Appl. No.: 12/382,007

(22) Filed: Mar. 5, 2009

(30) Foreign Application Priority Data
Mar. 6, 2008 (JP) P2008-056178
Mar. 4, 2009 (JP) P2009-050802

(51) Int. Cl. G03B 21/14

(52) U.S. Cl. 353/20

(57) ABSTRACT

A projection type image display device includes a LED light source, a polarizing plate, a crossdichroic mirror, three reflective spatial light modulation elements and a projection lens. The LED light source emits lights with three wavelengths. The polarizing plate transmits a first linear polarized light therethrough and reflects a second linear polarized light. The crossdichroic mirror separates the first linear polarized light into three separated lights according to the wavelengths and emits as three separated linear polarized lights, and combines lights entering and emits from an entering direction of the first linear polarized light. The crossdichroic mirror includes two color separation filters arranged so as to be inclined at about 45 degrees with respect to light entering. The two color separation filters meet a condition that a phase difference between a p-polarized light component and an s-polarized light component is equal to or less than 15 degrees in the wavelengths of the three separated linear polarized lights.

### BACKGROUND OF THE INVENTION

1. Field of the Invention

The present invention relates to a projection type image display device using a reflective spatial light modulation element.

2. Description of the Related Art

FIG. 1 is a block diagram illustrating a conventional projection type image display device disclosed in a patent document 1 (Japanese Unexamined Patent Application Publication No. 2007-3809).

In FIG. 1, white light emitted from a light source 1 goes through a light pipe (rod integrator) 2, and then enters a cross dichroic mirror 4 through a condenser lens 3.

The light source 1 is a lamp such as a metal halide lamp and emits intense white light. The light pipe 2 guides white light having entered from the light source 1. The guided white light is reflected on the inner surface of the light pipe 2 several times, which equalizes the illumination distribution of the guided white light, and then exits.

The cross dichroic mirror 4 is composed of two dichroic mirrors 4a and 4b combined crisscross. One dichroic mirror 4a reflects blue light B and the other dichroic mirror 4b reflects red/green light RG. The blue light B reflected on the dichroic mirror 4a is reflected on a mirror 5 to polarize, and then enters a reflective polarizing plate 7 through a relay lens 6. The blue light B is converted into p-polarized light by the reflective polarizing plate 7, goes through as polarized blue light PB, and enters a reflective spatial light modulation element 8.

On the other hand, the red/green light RG reflected on the dichroic mirror 4b is reflected on a mirror 9 to polarize, and then enters a dichroic mirror 10. The dichroic mirror 10 transmits red light R from the red/green light RG and reflects green light G. The red light R having gone through the dichroic mirror 10 enters a reflective polarizing plate 12 through a relay lens 11. The red light R is converted into p-polarized light by the reflective polarizing plate 12, goes through as polarized red light PR, and enters a reflective spatial light modulation element 13.

In contrast, the green light G reflected on the dichroic mirror 10 enters a reflective polarizing plate 15 through a relay lens 14. The green light G is converted into p-polarized light by the reflective polarizing plate 15, goes through as polarized green light PG, and enters a reflective spatial light modulation element 16.

The polarized blue light PB, the polarized red light PR and the polarized green light PG having entered the reflective spatial light modulation elements 8, 13 and 16 are modulated by image signal input into the reflective spatial light modulation elements 8, 13 and 16 and are polarized-and-modulated into s-polarized light, and then emitted to the reflective polarizing plates 7, 12 and 15 as polarized-and-modulated blue light SMB, polarized-and-modulated red light SMR and polarized-and-modulated green light SMG.

The polarized-and-modulated blue light SMB, the polarized-and-modulated red light SMR and the polarized-and-modulated green light SMG are reflected by the reflective polarizing plates 7, 12 and 15, and enter a crossdichroic prism 17 which forms a color combine optical system. The crossdichroic prism 17 is a cubic prism in which four triangular prisms 17a-17d are jointed, wherein dichroic coatings are formed on joint surfaces of respective triangular prisms 17a-17d. Here, joint surfaces of the triangular prisms 17a and 17b are defined as a plane a and joint surfaces of the triangular prisms 17c and 17d are defined as a plane a′. Also, joint surfaces of the triangular prisms 17a and 17d are defined as a plane b and joint surfaces of the triangular prisms 17b and 17c are defined as a plane b′. Two planes a-a′ and b-b′ formed by the four dichroic coatings 17a-17d are cruciately crossed at the center of crossdichroic prism 17.

One plane b-b′ reflects the entering polarized-and-modulated blue light SMB toward the side of projection lens 18, transmits the entering polarized-and-modulated red light SMR, and transmits the entering polarized-and-modulated green light SMG and emits it toward the side of projection lens 18. The other plane a-a′ reflects the entering polarized-and-modulated red light SMR toward the side of projection lens 18, transmits the entering polarized-and-modulated blue light SMB, and transmits the entering polarized-and-modulated green light SMG and emits it toward the side of projection lens 18.

Thus, the polarized-and-modulated blue light SMB, the polarized-and-modulated red light SMR and the polarized-and-modulated green light SMG having exited the crossdichroic prism 17 are combined in space and then enter the projection lens 18. The projection lens 18 causes the combined light having entered to be focused on a screen not shown to display an enlarged image on the screen.

The light source of the conventional projection type image display device uses very bright white light as illuminating light, which needs to cool the light source using a large cooling fun at a time of the projection because high heat is generated on the light source itself. As the result, it has a problem that the whole device increase in size, noise occurs due to rotation sound of the cooling fan, and life cycle of the light source itself is relatively shortened.

Also, the conventional projection type image display device has a problem that the whole device increases in size and weight because it is configured to arrange various optical parts at certain positions between the condenser lens 3 and the crossdichroic prism 17 on respective optical paths of color lights R, G and B in order to project an image in higher contrast and higher brightness.

### SUMMARY OF THE INVENTION

The present invention is invented in order to solve the above-described problems, and has an object to provide a space-saving and lightweight projection type image display device capable of reducing noise using a small and low-heat-generating light source and projecting a projection image in low color blurring, high contrast and high fineness.

The present invention provides a projection type image display device that has the configuration of (1) to (4) described below, in order to solve the above-described problems.

(1) A projection type image display device comprising: a light source that emits lights with three different wavelengths; a polarizing plate that transmits a first linear polarized light therethrough and reflects a second linear polarized light from among the lights entering; a color separation and combine means that, when the first linear polarized light transmitted through the polarizing plate enters, separates the first linear polarized light into three separated lights according to the wavelengths and emits as three separated linear polarized lights in three different directions and, when lights with the different wavelengths enter from respective directions opposed to the three different directions, combines the lights with the different wavelengths and emits as a combined modulated-and-polarized light toward a direction opposed to the entering direction of the first linear polarized light; three reflective spatial light modulation elements that are arranged on respective optical paths of the three separated linear polarized lights emitted in the three different directions, and light-modulates and reflects the separated linear polarized lights entering; and a projection means that enlarges and projects the second linear polarized light reflected by the polarizing plate from among the combined modulated-and-polarized light light-modulated by the three reflective spatial light modulation elements and combined by the color separation and combine means, wherein the color separation and combine means includes a first color separation filter and a second color separation filter arranged so as to be inclined at about 45 degrees with respect to light entering, and the first color separation filter and the second color separation filter meet a condition that a phase difference between a phase of a polarized light component parallel to an entrance surface and a phase of a polarized light component orthogonal to the polarized light component parallel to the entrance surface is equal to or less than 15 degrees in the respective wavelengths of the three separated linear polarized lights.

(2) The projection type image display device according to (1), wherein the first color separation filter and the second color separation filter meet

(cos² θ+sin^{2 θ*}e^{-iα})²/(sin θ*cos θ−sin θ*cos θ*e^{-iα})²≧2500,

where an angle formed between the first linear polarized light and a polarized light parallel to the entrance surface is θ and the phase difference is α.

(3) The projection type image display device according to (1), wherein the color separation and combine means is a crossdichroic mirror in which the first color separation filter and the second color separation filter are orthogonal to each other.

(4) The projection type image display device according to (1), wherein the color separation and combine means comprises: a first polarizing beam splitter that reflects a first color component light and transmits a second color component light and a third color component light therethrough from among lights entering; and a second polarizing beam splitter that, when the second color component light and the third color component light enter, reflects the second color component light and transmits the third color component light therethrough.

According to the projection type image display device of the present invention, it employs an illumination means that combines a red light R, a green light G and a blue right B with narrow wavelength bands emitted from a light source of respective color lights of red-green-blue RGB, and can well prevent unnecessary polarization rotation of image light generated by a combine optical system to obtain a projection image in high contrast, low color blurring and high fineness and realize the reduction in size and weight.

### BRIEF DESCRIPTION OF THE DRAWINGS

FIG. 1 is a block diagram that illustrates a conventional projection type image display device.

FIG. 2 is a block diagram that illustrates a first embodiment of a projection type image display device of the present invention.

FIG. 3 is a block diagram in which A portion of FIG. 2 is enlarged.

FIG. 4 is an explanatory diagram that illustrates lights entering a crossdichroic prism and polarizing axes of the lights.

FIG. 5A and FIG. 5B are graphs each of which shows wavelength selectivity on joint surfaces of triangular prisms forming the crossdichoroic prism.

FIG. 6 is an explanatory diagram that illustrates the relation between an entrance polarizing axis and a polarizing angle.

FIG. 7 is an explanatory diagram that illustrates the relation between a phase difference of dichroic coating and a contrast.

FIG. 8 is a table that shows a layered structure of the dichroic coating.

FIG. 9 is a block diagram that illustrates a second embodiment of the projection type image display device of the present invention.

### DESCRIPTION OF THE PREFERRED EMBODIMENTS

### First Embodiment

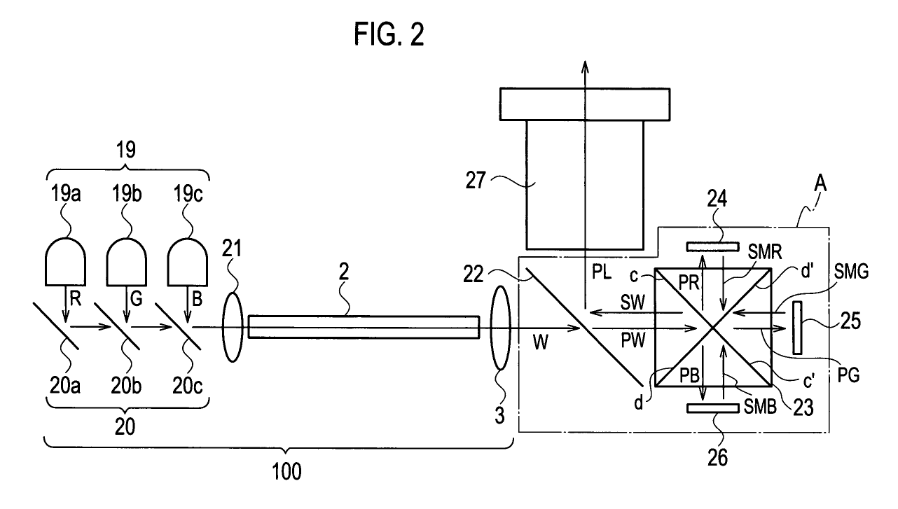

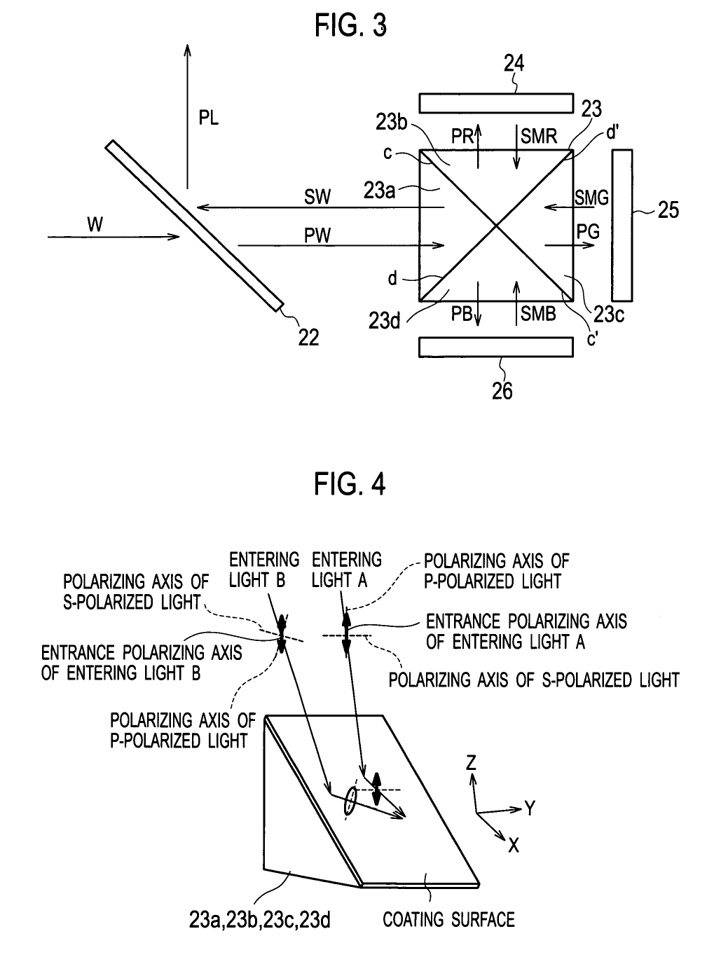

A first embodiment of a projection type image display device of the present invention will be described below, with reference to FIG. 2 and FIG. 3. In the description, the same symbol is assigned to the same component part as that described previously.

The projection type image display device of the present embodiment includes an illumination means (illumination unit) 100, a polarizing plate 22, a color separation and combine means (crossdichroic prism) 23, three reflective spatial light modulation elements 24, 25 and 26, and a projection means (projection lens) 27.

The illumination unit 100 includes a three color light source 19 (19a, 19b and 19c) of red-green-blue RGB, three dichroic mirrors 20 (20a, 20b and 20c), a collective lens 21, a light pipe 2 and a condenser lens 3.

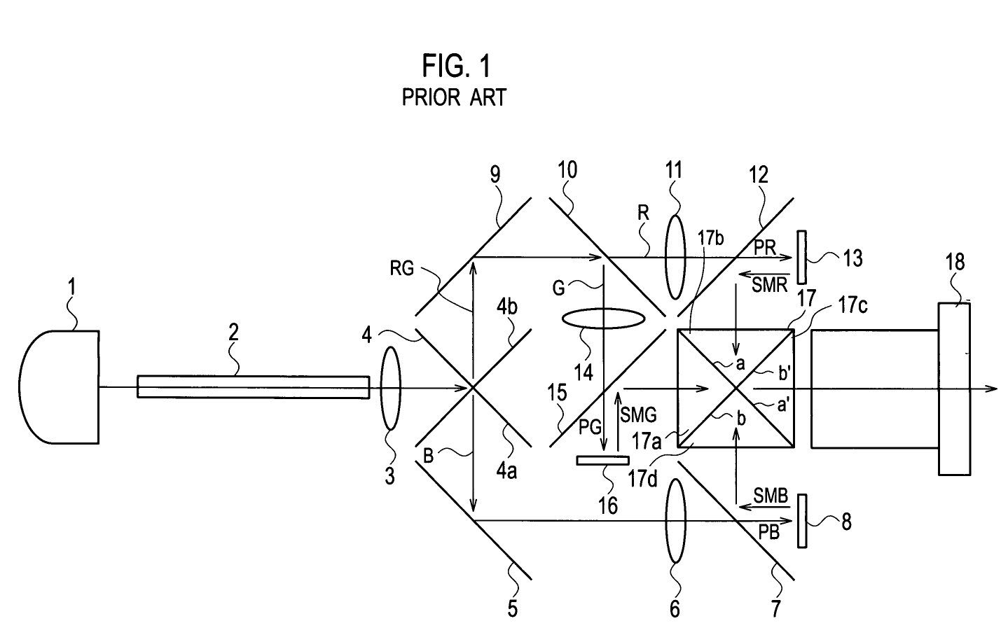

The light source 19 is composed of a red light source 19a which is a semiconductor light source for emitting red light R with a narrow wavelength band in which wavelength is within the range of 600 nm to 700 nm, a green light source 19b which is a semiconductor light source for emitting green light G with a narrow wavelength band in which wavelength is within the range of 480 nm to 600 nm, and a blue light source 19c which is a semiconductor light source for emitting blue light B with a narrow wavelength band in which wavelength is within the range of 400 nm to 480 nm, and is a red-green-blue light emitting diode (LED) for example. The red light source 19a, the green light source 19b and the blue light source 19c do not produce high heat in light emitting state, in comparison with the light source 1 illustrated in FIG. 1, because they are semiconductor light sources.

Lights emitted from the light source 19 enter the dichroic mirrors 20 which are inclined at about 45 degrees with respect to respective light axes and arranged in parallel with one another.

Here, the dichroic mirrors 20 are composed of a red dichroic mirror 20a, a green dichroic mirror 20b and a blue dichroic mirror 20c arranged corresponding to the red light source 19a, the green light source 19b and the blue light source 19c.

Also, the dichroic mirrors 20 are configured to reflect lights from the semiconductor light sources for respective colors.

The three dichroic mirrors 20 respectively reflect red, green and blue lights R, G and B entering from the respective light sources 19a-19c to bend light axes at 90 degrees, and are composed of the dichroic mirrors 20a-20c for combining red, green and blue lights R, G and B. Red-green-blue light RGB combined in the dichroic mirrors 20a-20c enters the collective lens 21 as illumination light W. The collective lens 21 collects the entering illumination light W toward the light pipe 2 and emits it.

The light pipe 2 is formed in a polygonal column shape or a substantially multi-sided pyramid shape in which an inner wall is composed of mirrors. In this embodiment, the light pipe 2 is formed in a hollow truncated pyramid structure in which four mirrors are joined in a longitudinal direction. The illumination light W which exited the collective lens 21 has been collected, and enters the light pipe 2 from an entrance side of the light pipe 2 and is reflected on the inner wall surface of the light pipe 2 several times, which has the function that uniforms the illumination distribution and the luminance distribution of light flux in a direction orthogonal to an light axis at an exit side of the light pipe 2 and then emits it.

It is noted that the entering light may be guided using total reflection on glass as the light pipe 2.

The illumination light W having gone through the light pipe 2 is diffusion light and is turned into collective light by going through the collective lens 3. The illumination light W turned into the collective light enters the polarizing plate 22.

An optical path of illumination light which exited the collective lens 3 will be described using FIG. 3.

The polarizing plate 22 is a reflective polarizing plate so-called “wire grid” and is arranged to be inclined at about 45 degrees with respect to a light axis of the illumination light W. The illumination light W entering the polarizing plate 22 is in a random state where the polarizing state is irregular, and the polarizing plate 22 transmits only p-polarized light of the illumination light W and emits it as polarized illumination light PW toward the crossdichroic prism 23.

It is noted that, at the stage before the illumination light W enters the polarizing plate 22, the illumination light W may be polarization-converted into the p-polarized light by a well-known polarization conversion element or the like and then enter the polarizing plate 22 as the polarized illumination light PW with the p-polarized light.

The crossdichroic mirror 23 is a quadratic prism in which two side surfaces of respective four triangular prisms 23a-23d are jointed. Dichroic coatings which are color separation filters are formed on four abutting surfaces of the triangular prisms 23a-23d. Here, an abutting surface of the triangular prisms 23a and 23b are defined as a plane c and an abutting surface of the triangular prisms 23c and 23d are defined as a plane c′. Also, an a butting surface of the triangular prisms 23a and 23d are defined as a plane d and an abutting surface of the triangular prisms 23b and 23c are defined as a plane d′. Two continuous planes c-c′ and d-d′ formed by four dichroic coatings are cruciately crossed at the center of crossdichroic prism 23.

Dichroic coatings forming one continuous plane c-c′ of the crossdichroic prism 23 have wavelength selectivity that reflects a blue (B) light component of entering light (polarized illumination light PW), and transmits a green (G) light component and a red (R) light component of entering light and emits them. Dichroic coatings forming the other continuous plane d-d′ of the crossdichroic prism 23 have wavelength selectivity that reflects a red (R) light component of entering light, and transmits a green (G) light component and a blue (B) light component of entering light and emits them.

More specifically, the dichroic coatings forming one continuous plane c-c′ of the crossdichroic prism 23 carry out wavelength separation of blue polarized light PB from the entering polarized illumination light PW and reflects the blue polarized light PB toward the side of the reflective spatial light modulation element for blue (B) light 26, and as well carry out wavelength separation of green polarized light PG and red polarized light PR from the polarized illumination light PW and transmit and emit them.

The dichroic coatings forming the other continuous plane d-d′ of the crossdichroic prism 23 carry out wavelength separation of red polarized light PR from the entering polarized illumination light PW and reflects the red polarized light PR toward the side of the reflective spatial light modulation element for red (R) light 24, and as well carry out wavelength separation of green polarized light PG and blue polarized light PB from the polarized illumination light PW and transmit and emit them.

Thereby, the red polarized light PR enters the reflective spatial light modulation element for red (R) light 24, the green polarized light PG enters the reflective spatial light modulation element for green (G) light 25, and the blue polarized light PB enters the reflective spatial light modulation element for blue (B) light 26.

The red polarized light PR, the green polarized light PG and the blue polarized light PB entering the reflective spatial light modulation elements for respective color lights 24, 25 and 26 are modulated based on image signals input from outside, and emitted to the dichroic coatings forming the planes c-c′ and d-d′ as polarized-and-modulated red light SMR, polarized-and-modulated green light SMG and polarized-and-modulated blue light SMB.

The dichroic coatings forming one plane c-c′ of the crossdichroic prism 23 reflect and emit toward the side of the polarizing plate 22 the polarized-and-modulated blue light SMB entering from the reflective spatial light modulation element for blue (B) light 26, transmit and emit toward the side of the polarizing plate 22 the polarized-and-modulated green light SMG entering from the reflective spatial light modulation element for green (G) light 25, and transmit the polarized-and-modulated red light SMR entering from the reflective spatial light modulation element for red (R) light 24.

The dichroic coatings forming the other plane d-d′ of the crossdichroic prism 23 reflect and emit toward the side of the polarizing plate 22 the polarized-and-modulated red light SMR entering from the reflective spatial light modulation element for red (R) light 24, transmit and emit toward the side of the polarizing plate 22 the polarized-and-modulated green light SMG entering from the reflective spatial light modulation element for green (G) light 25, and transmit the polarized-and-modulated blue light SMB entering from the reflective spatial light modulation element for blue (B) light 26.

At this time, in the crossdichroic prism 23, the polarized-and-modulated blue light SMB, the polarized-and-modulated red light SMR and the polarized-and-modulated green light SMG are combined on one plane c-c′ and the other plane d-d′ of the crossdichroic mirror 23 and exit as polarized-and-modulated white light SW.

Thus, the polarized-and-modulated white light SW having exited the crossdichroic mirror 23 enters the polarizing plate 22 again, and an s-polarized light component of the polarized-and-modulated white light SW generated by modulation is reflected by the polarizing plate 22 and exits as projection light PL. The projection light PL having exited the polarizing plate 22 enters the projection lens 27 which is the projection means. The projection lens 27 causes the projection light PL having entering from the polarizing plate 22 to be focused on a screen not shown to display an enlarged image on the screen.

Here, the relation between light entering the crossdichroic mirror 23 and contrast will be described.

Light entering coating surfaces of dichroic coatings of the four triangular prisms 23a-23d of the crossdichroic prism 23 goes through the polarizing plate 22 which is a wire grid polarizing plate, to be turned into linear polarized light, before entering. A polarizing axis of the linear polarized light is defined as an entrance polarizing axis.

At this time, a polarizing axis of p-polarized light is parallel to a plane formed by entering light and reflecting light, and a polarizing axis of s-polarized light is orthogonal to the plane formed by the entering light and the reflecting light.

This causes an angle between the polarizing axis of p-polarized light and the entrance polarizing axis to differ according to an angle of an entering light beam which enters a coating surface of the crossdichroic prism 23. For example, as shown in FIG. 4, entering light A and entering light B are linear polarized lights which have the same entrance polarizing axes. When the entering light A of which a traveling direction of light beam is parallel to XZ-plane and in which the entrance polarizing axis is coincident with a polarizing axis of p-polarized light is reflected on a coating surface, a polarizing direction of the entrance polarizing axis is kept to be coincident with the polarizing axis of p-polarized light without rotating. However, when the entering light B, entering the coating surface of the crossdichroic prism 23 at an angle (θ) relative to the coating surface in Y-direction, of which a traveling direction of light beam is no parallel to XZ-plane and in which the entrance polarizing axis is not coincide with a polarizing axis of p-polarized light is reflected on the coating surface, a polarizing direction of the entrance polarizing axis rotates so that the linear polarized light is turned into elliptically polarized light.

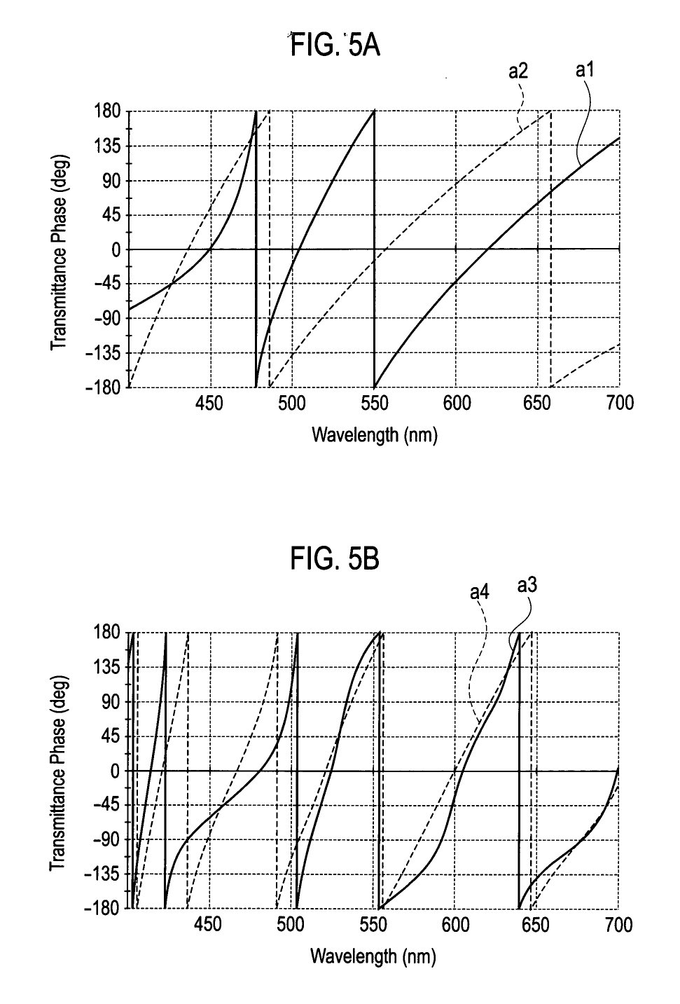

Further, in a case where spectroscopic characterization of dichroic coatings of the crossdichroic prism 23 causes a phase difference (a) between s-polarized light and p-polarized light to occur in wavelength of entering light, an entrance polarizing direction rotates. For example, in a case of the LED light source 19 employed in this embodiment, when a wavelength of the red light source 19a is 630 nm, a wavelength of the green light source 19b is 530 nm, and a wavelength of the blue light source 19c is 460 nm, the phase difference (α) between s-polarized light a1 and p-polarized light a2 has a large value as shown in FIG. 5A which is more than about 100 degrees at 630 nm, about 180 degrees at 530 nm, or 50 degrees at 460 nm. This causes an entrance polarizing axis of light entering the dichroic coatings of the crossdichroic prism 23 to rotate largely.

At this time, polarized components (s-polarized lights) which are modulated in the reflective spatial light modulation elements for respective color lights 24, 25 and 26 are reflected by the polarizing plate 22, and then enlarged by the projection lens 27 to be projected on a screen not shown as an image. On the other hand, polarized components (p-polarized lights) which are not modulated in the reflective spatial light modulation elements for respective color lights 24, 25 and 26 go through the polarizing plate 22, and then returns to the side of the light source 19. At this time, polarized light is changed on the dichroic coatings of the crossdichroic mirror 23. When the polarized light (p-polarized light) not modulated is turned into s-polarized light, the polarized light is reflected, which projects the polarized components not modulated on the screen. This deteriorates contrast of image.

In other words, the difference between phase changes due to the difference between polarizing directions prevents an image portion to be projection-replicated at simple black from being replicated at simple black, and allows another color to run at a boundary edge of the image portion. As the result, this deteriorates contrast of image at the area.

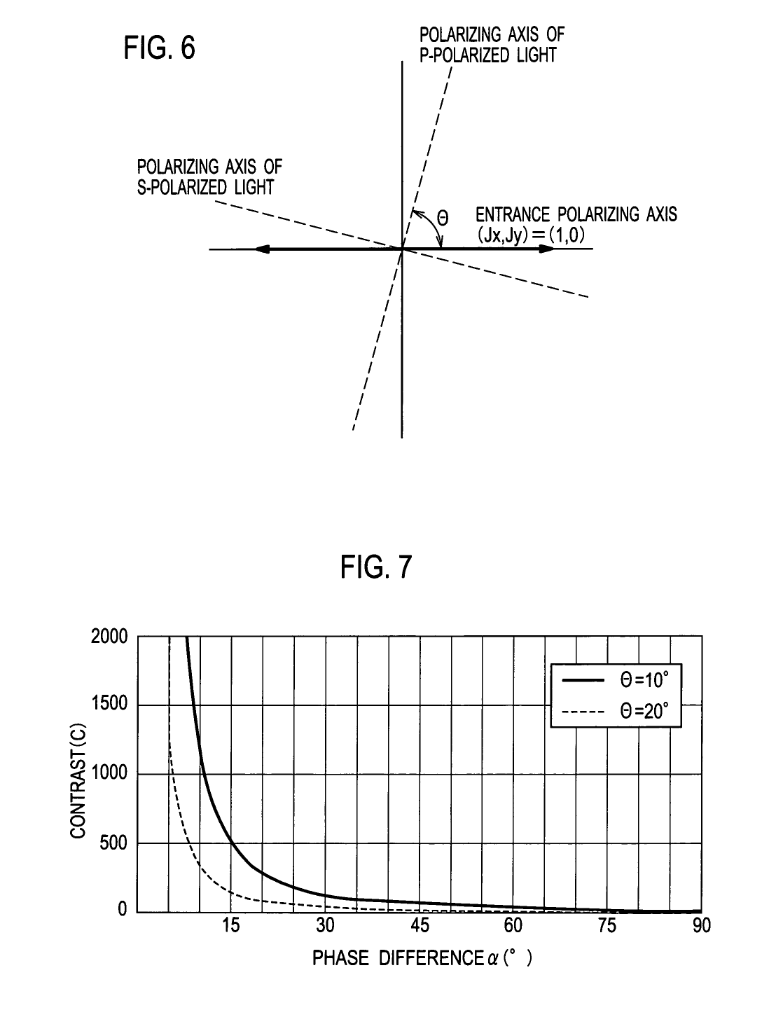

Here, in a case where we assume that a polarization state of entering light is described as (Jₓ, J_{y})=(1, 0) using Jones Vector as shown in FIG. 6, an angle (angle of deflection) between a polarizing axis of entering light and a polarizing axis of p-polarized light is θ, and a phase difference (α) between s-polarized light and p-polarized light occurs on a dichroic coating, Jones Vector (J_{x′}, J_{y′}) of light emitted from a coating surface is described as the following eq.1.

$$( \begin{matrix}{J}_{{X}^{′}} \\ {J}_{{Y}^{′}}\end{matrix} ) = ( \begin{matrix}cos θ & - sin θ \\ sin θ & cos θ\end{matrix} ) ( \begin{matrix}1 & 0 \\ 0 & {e}^{- i α}\end{matrix} ) ( \begin{matrix}cos θ & sin θ \\ - sin θ & cos θ\end{matrix} ) ( \begin{matrix}1 \\ 0\end{matrix} )$$

At this time, contrast (C) is described as the following eq.2.

C=(cos² θ+sin² θ*e^{-iα})²/(sin θ*cos θ−sin θ*cos θ*e^{-iα})²

Further, FIG. 7 shows a relation between a phase difference (α) and contrast when angles of deflection (θ) are 10 degrees or 20 degrees.

According to eq.2 and FIG. 7, when θ=0 or α=0, contrast (C) reaches an infinity value.

When an image is projected by the projection type image display device, even if a projection place is a bright place, the image is recognized if contrast (C) is equal to or more than 500:1.

Therefore, it is requested in a dichroic coating and an optical system of the crossdichroic prism 23 that an angle of deflection (θ) and a phase difference (α) meets the following eq.3.

(cos² θ+sin² θ*e^{-iα})²/(sin θ*cos θ−sin θ*cos θ*e^{-iα})≧500

Namely, as shown in FIG. 7, for example, in a case where an angle of deflection (θ) is 10°, when a phase difference (α) is equal to or less than 15°, contrast is equal to or more than 500:1. Also, if a phase difference (α) between s-polarized light and p-polarized light is decreased by coating design of dichroic coatings of the crossdichroic prism 23, deterioration of contrast can be prevented. Further, even if the angle of deflection (θ) increases, the deterioration of contrast (C) can be prevented by relatively decreasing the phase difference (α).

Next, as an example, a case that each dichroic coating of the crossdichroic prism 23 is formed using a silicon dioxide SiO₂ coating and a titanium dioxide TiO₂ coating in 22 layers laminated structure will be described.

In this example, the coating design is carried out under the assumption that wavelengths of the red light source 19a, the green light source 19b and the blue light source 19c as the LED light source 19 are 630 nm, 530 nm and 460 nm.

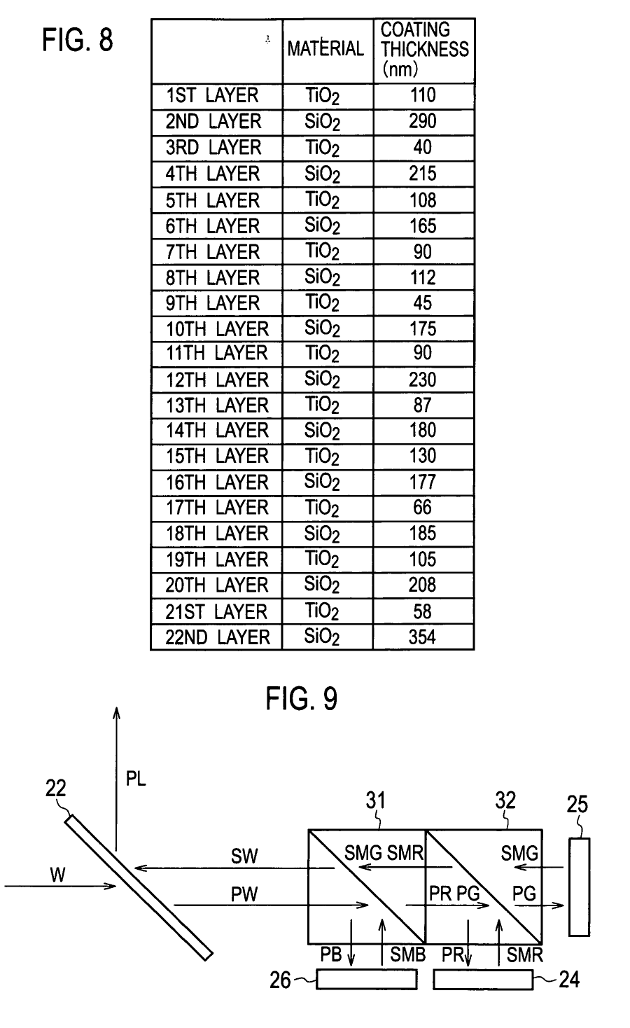

FIG. 8 illustrates a layer structure and a coating thickness of each layer used in the example. As shown in FIG. 8, a SiO₂ coating with low refractive index and a TiO₂ coating with high refractive index are alternately laminated, and the coating thickness of each layer is adjusted to a certain value.

A characteristic of the crossdichroic prism 23 using the dichroic coatings formed in the above structure is shown in FIG. 5B. In FIG. 5B, s-polarized light is indicated in a3 and p-polarized light is indicated in a4.

In FIG. 5B, a phase difference (α) between the s-polarized light a3 and the p-polarized light a4 emitted from the LED light sources 19a, 19b and 19c is about 0 in all wavelengths.

As this result, the projection type image display device of this example can improve contrast (C).

In the first embodiment, the dichroic coatings forming the plane c and the plane d in the four abutting surfaces (the plane c, the plane c′, the plane d and the plane d′) of the crossdichroic prism 23 may have wavelength selectivity such that the dichroic coating forming the plane c reflects a blue (B) light component of entering light (polarized illumination light PW) and transmits a green (G) light component and a red (R) light component of entering light and emits them, the dichroic coating forming the plane d reflects a red (R) light component of entering light and transmits a green (G) light component and a blue (B) light component and emits them, the dichroic coating forming the plane c′ reflects a blue (B) light component of entering light (polarized illumination light PW) and transmits a green (G) light component and emits it, and the dichroic coating forming the plane d′ reflects a red (R) light component of entering light and transmits a green (G) light component and emits it.

### Second Embodiment

As another embodiment, a projection type image display device using two polarizing beam splitters instead of the crossdichroic prism in FIG. 2 will be described.

A projection type image display device in FIG. 9 shows only a portion corresponding to the A portion of FIG. 2, and the other portions are omitted because the other portions are common to those of FIG. 2.

The projection type image display device of the second embodiment includes a polarizing plate 22, and a first polarizing beam splitter 31 and a second polarizing beam splitter 32 which are set among the three reflective spatial light modulation elements 24, 25 and 26 as the color separation and combine means, instead of the crossdichroic prism 23.

Dichroic coatings are formed in the first polarizing beam splitter 31 and the second polarizing beam splitter 32, so as to be arranged to be inclined at about 45 degrees with respect to respective entering lights.

The first polarizing beam splitter 31 has wavelength selectivity that reflects a blue (B) light component of entering light, and transmits a green (G) light component and a red (R) light component of entering light and emits them.

The second polarizing beam splitter 32 has wavelength selectivity that reflects a red (R) light component of entering light, and transmits a green (G) light component of entering light and emits it.

The illumination light W, which is combined to be white light by being emitted from the light source 19 and reflected by the dichroic mirror 20, enters the polarizing plate 22 through the collective lens 21, the light pipe 2 and the collective lens 3, and then exits as the polarized illumination light PW with the p-polarized light. The polarized illumination light PW having exited the polarizing plate 22 enters the first polarizing beam slitter 31, and wavelength separation is carried out by the first polarizing beam splitter 31 such that blue polarized light PB is reflected toward the side of the reflective spatial light modulation element for blue (B) light 26, and green polarized light PG and red polarized light PR go through and then exit.

The green polarized light PG and the red polarized light PR having gone through the first polarizing beam splitter 31 enters the second polarizing beam splitter 32.

Wavelength separation is carried out with respect to the green polarized light PG and the red polarized light PR entering the second polarizing beam splitter 32 by the second polarizing beam splitter 32 such that the red polarized light PR is reflected toward the side of the reflective spatial light modulation element for red (R) light 24, and the green polarized light PG is reflected toward the side of the reflective spatial light modulation element for green (G) light 25.

The red polarized light PR, the green polarized light PG and the blue polarized light PB entering the reflective spatial light modulation element for blue (B) light 26, the reflective spatial light modulation element for red (R) light 24 and the reflective spatial light modulation element for green (G) light 25 are modulated based on image signals input from outside and reflected as polarized-and-modulated red light SMR, polarized-and-modulated green light SMG and polarized-and-modulated blue light SMB, in the respective reflective spatial light modulation elements 24, 25 and 26.

The polarized-and-modulated red light SMR and the polarized-and-modulated green light SMG enters the second polarizing beam splitter 32 and are combined and exit. The polarized-and-modulated blue light SMB enters the first polarizing beam splitter 31, is combined with the polarized-and-modulated red light SMR and the polarized-and-modulated green light SMG entering from the second polarizing beam splitter 32, and exits the second polarizing beam splitter 32 as polarized-and-modulated white light SW.

The polarized-and-modulated white light SW emitted from the second polarizing beam splitter 32 enters the polarizing plate 22, and an s-polarized light component of the polarized-and-modulated white light SW generated by modulation is reflected by the polarizing plate 22 and exits as projection light PL. The projection light PL having exited the polarizing plate 22 enters the projection lens 27 which is the projection means. The projection lens 27 causes the projection light PL having entering from the polarizing plate 22 to be focused on a screen not shown to display an enlarged image on the screen.

Since lights entering the first polarizing beam splitter 31 are red polarized light PR, green polarized light PG and blue polarized light PB as well as the crossdichoric prism 23 of the first embodiment, it is necessary to adjust a phase difference according to wavelengths of polarized lights of three colors. However, in the second embodiment, since lights entering the second polarizing beam splitter 32 are red polarized light PR and green polarized light PG, it is only necessary to adjust a phase difference according to wavelengths of polarized lights of two colors. Therefore, coating design of dichroic coating to be used in the second polarizing beam splitter 32 is easier than that to be used in the first polarizing beam splitter 31.

In the second embodiment, although FIG. 9 illustrates the dichroic coating of the first polarizing beam splitter 31 and the dichroic coating of the second polarizing beam splitter 32 such that they are arranged to be substantially parallel to each other, they may be arranged to be substantially perpendicular to each other.

What is claimed is:

1. A projection type image display device comprising:
a light source that emits lights with three different wavelengths;
a polarizing plate that transmits a first linear polarized light therethrough and reflects a second linear polarized light from among the lights entering;
a color separation and combine means that, when the first linear polarized light transmitted through the polarizing plate enters, separates the first linear polarized light into three separated lights according to the wavelengths and emits as three separated linear polarized lights in three different directions and, when lights with the different wavelengths enter from respective directions opposed to the three different directions, combines the lights with the different wavelengths and emits as a combined modulated-and-polarized light toward a direction opposed to the entering direction of the first linear polarized light;
three reflective spatial light modulation elements that are arranged on respective optical paths of the three separated linear polarized lights emitted in the three different directions, and light-modulates and reflects the separated linear polarized lights entering; and
a projection means that enlarges and projects the second linear polarized light reflected by the polarizing plate from among the combined modulated-and-polarized light light-modulated by the three reflective spatial light modulation elements and combined by the color separation and combine means,
wherein
the color separation and combine means includes a first color separation filter and a second color separation filter arranged so as to be inclined at about 45 degrees with respect to light entering, and
the first color separation filter and the second color separation filter meet a condition that a phase difference between a phase of a polarized light component parallel to an entrance surface and a phase of a polarized light component orthogonal to the polarized light component parallel to the entrance surface is equal to or less than 15 degrees in the respective wavelengths of the three separated linear polarized lights.

2. The projection type image display device according to claim 1, wherein the first color separation filter and the second color separation filter meet
(cos² θ+sin² θ*e^{-iα})/(sin θ*cos θ−sin θ*cos θ*e^{-iα})²≧500,
where an angle formed between the first linear polarized light and a polarized light parallel to the entrance surface is θ and the phase difference is α.

3. The projection type image display device according to claim 1, wherein the color separation and combine means is a crossdichroic mirror in which the first color separation filter and the second color separation filter are orthogonal to each other.

4. The projection type image display device according to claim 1, wherein the color separation and combine means comprises:
a first polarizing beam splitter that reflects a first color component light and transmits a second color component light and a third color component light therethrough from among lights entering; and
a second polarizing beam splitter that, when the second color component light and the third color component light enter, reflects the second color component light and transmits the third color component light therethrough.
